(19) United States
(12) Patent Application Publication
(10) Pub. No.: US 2024/0427865 A1
(43) Pub. Date: Dec. 26, 2024

(54) AUTHORIZING AN APPLICATION ON A SECURITY ELEMENT

(71) Applicant: GIESECKE+DEVRIENT EPAYMENTS GMBH, Munchen (DE)

(72) Inventors: Oliver GIBIS, Munchen (DE); Werner NESS, Unterschleissheim (DE); Alexander SUMMERER, Poing (DE)

(21) Appl. No.: 18/701,762

(22) PCT Filed: Oct. 18, 2022
(86) PCT No.: PCT/EP2022/000097

§ 371 Date: Apr. 16, 2024

(30) Foreign Application Priority Data
Oct. 27, 2021 (DE) 10 2021 005 350.8

(51) Int. Cl. G06F 21/32; G06F 21/44; G06F 21/60

(52) U.S. Cl. CPC G06F 21/32; G06F 21/44; G06F 21/602

(57) ABSTRACT

A method for authorizing an application installed on a security element includes the steps of capturing a user feature by a sensor of a user verification element and generating sensor data that characterize the user feature; deriving a user verification status from the sensor data by the user verification element; and transmitting the user verification status from the user verification element to the security element for the purpose of authorizing the application by way of the security element.

The present invention relates to a method for authorizing an application installed on a security element and to a corresponding device comprising a security element and a user verification element.

Mobile devices that can be used for digital transactions, such as digital payment or the like, are known. Such devices may be designed, for example, as watches or keychains, but also as telecommunication terminals, such as cell phones or the like. It is often advantageous to equip these devices with a means of user verification, for example by means of a biometric check, in order to secure transactions.

However, the applications that are required for a transaction and are frequently installed on and run by the relevant security elements cannot be modified by the manufacturer of the devices, for example because certification or other security requirements do not permit this.

In other cases, the applications are provided as binary code by third party providers and the source code is not available at all to the manufacturer of said devices. For example, in order to secure transactions, the third party provider must therefore be tasked with a corresponding modification. In order to modify all relevant applications accordingly, different types of biometric checks may need to be considered individually and/or different third party providers may need to be involved. This regularly results in additional certification or re-certification of applications, resulting in significant costs and time.

In this respect, the object of the present invention is to propose a solution that overcomes the above-mentioned and other disadvantages of the prior art.

This object is achieved by a method and a device according to the independent claims. Further configurations and preferred embodiments of the invention are specified in the dependent claims.

The present invention relates to authorizing an application installed on a security element and comprises a plurality of steps: According to a first step, a user feature of a user is captured by means of a sensor of a user verification element and sensor data that characterize the user feature are determined therefrom. In a second step, the user verification element derives a user verification status of the user from the sensor data. In a third step, the derived user verification status is transmitted from the user verification element to the security element for the purpose of authorizing the application by way of the security element and the application is authorized on the basis of the user verification status.

The invention characterized in this way makes it possible to provide a security element having applications installed on it with a user verification status and to use it there to authorize the application. Neither the security element or its operating system nor the application itself must carry out the user verification itself or be specifically adapted for this purpose. Already existing applications can be provided with access and/or transaction protection according to the invention without changing their source code or binary code, performing a new installation or re-certification, or otherwise having to modify the application. The user verification is modularized according to the invention and is thus decoupled from the actual authorization.

According to the invention, all aspects of user verification are accordingly bundled on a user verification element which is separate from the security element and provides the latter or the relevant application with the required user verification status for its authorization. Therefore, any security-related or user-specific or application-specific applications running on the security element do not need to be adapted for specific user verification.

The device according to the invention is suitably equipped and configured to check the authorization according to the invention of the application installed on the security element. For this purpose, the device according to the invention comprises a user verification element and a security element having applications installed thereon. The user verification element is configured to capture a user feature by means of the sensor and to derive therefrom a user verification status that characterizes the user feature. In addition, the user verification element is configured to transmit the user verification status to the security element. The security element is in turn configured to accept the user verification status and use it to authorize the application.

Preferably, the method according to the invention comprises the step of providing said device having the security element and user verification element. The security element and the user verification element are structurally separate here and maintain a data communication connection.

In addition to the sensor, the user verification element preferably comprises at least one sensor controller assigned to the sensor and a verification controller. Preferably, the security element in turn comprises an intermediation application. Whereas the sensor controller derives the user verification status from the sensor data, the verification controller transmits the user verification status to the security element or its intermediary application. In this context, depending on the user verification status, the intermediary application can allow or deny certain steps, such as authorizing the relevant application or denying authorization and preventing transactions from being carried out.

The sensor controller can determine whether a positive user verification status results from the sensor data and can forward the user verification status to the verification controller. In particular, the sensor controller can determine, independently of the other components of the device according to the invention, whether the user can be verified by the sensor data.

Preferably, according to a step of the method according to the invention, when a positive user verification status is determined by the sensor controller, at least one application on the security element is selected and/or a transaction is carried out with the at least one application. For example, if there is a positive user verification status, transactions with the security element are allowed.

User verification using the sensor and its sensor controller avoids the need to adapt the application required for the transaction in terms of security. These adaptations can be made in the intermediary application and the verification controller instead. Since user verification by means of sensor data is logically and preferably structurally separate from the applications of the security element and the user verification status is securely passed to the applications, modification of the applications, and thus a break of the corresponding certifications, is avoided.

The sensor is preferably a biometric sensor that generates sensor data that characterize a biometric user feature. Particularly preferably, the biometric sensor is a fingerprint sensor and the sensor controller is a fingerprint controller. This allows the user verification status to be easily determined because the user does not need to have any special items or prove knowledge. In particular, a biometric sensor relieves the load on the verification controller. In some cases, this can result in a lower energy requirement and a correspondingly longer battery life.

Preferably, the intermediary application of the security element, the verification controller and/or the sensor controller is/are pre-personalized by securely storing personalized data in these components. These data preferably comprise a key set with one or more cryptographic keys suitable for encrypting the data communication in question. Preferably, the same key set is stored in the intermediary application, verification controller and sensor controller during the pre-personalization. Alternatively, one key set can be used for communication between the verification controller and the sensor controller and a further key set can be used to communicate with the intermediary application.

Encryption of the data communication between the verification controller, intermediary application and/or sensor controller prevents unauthorized reading or manipulation of the user verification status by an attacker. The information and data transmitted between said components are at least partially secured with message authentication codes in order to ensure and be able to check the authenticity of the transmitted information and data.

The user verification status is preferably transmitted according to a security protocol which preferably uses a challenge-response method. Preferably, information is transmitted between the verification controller, intermediary application and/or sensor controller at least partially according to such a security protocol. This prevents manipulations of the user verification status, for example by means of logical attacks by malware in the verification controller or physical attacks on cable connections between the components. These measures enable secure communication across non-secure components of the device according to the invention.

According to the invention, an application is authorized by the intermediary application detecting a positive user verification status. In this case, the application can be selected and/or a transaction can be carried out using the application. Preferably, the user verification status is reset after selecting an application and/or carrying out a transaction using an application, such that further selection of applications and/or carrying-out of a transaction is/are only possible upon renewed user verification. If, for example, the device according to the invention is stolen after user verification and a subsequent transaction, a further, then unauthorized transaction is prevented.

The security element generally carries out transactions contactlessly by means of a suitable transmitting and receiving apparatus on the security element or verification controller, for example by means of an NFC or Bluetooth module with an antenna. The transmitting and receiving apparatus may be arranged, for example, on the security element or verification controller. A device configured for such a contactless transaction does not need any lines which are dangerous in terms of security and are routed to the outside.

Preferably, authentication transactions, payment transactions and/or access transactions are authorized according to the invention. An authentication transaction is used, for example, to authenticate a user who has previously been verified so that the user can carry out a payment transaction, for example, and/or gain access to a system or object.

According to some embodiments, the device according to the invention has the form of a keychain; in particular, it is a “key fob” with an integrated fingerprint sensor.

Preferably, the verification controller detects whether the user wants to perform user verification. In this case, the verification controller requests a challenge from the intermediation application, such as a random number, which is preferably protected with a message authentication code, for example by means of an HMAC code.

The sensor controller then checks the integrity of the challenge using the message authentication code. If the message authentication code of the challenge is positive, the sensor controller preferably performs user verification and determines a user verification status.

The sensor controller then checks the integrity of the challenge using the message authentication code and, if integrity exists, performs user verification and determines a user verification status. The sensor controller then transmits the encrypted and secured user verification status to the verification controller which forwards it to the intermediary application which decrypts the user verification status and stores it when the associated message authentication code is identified as correct. The operating system of the security element can access the user verification status stored in this way and, in the event of a positive user verification status, allows the application to be selected and/or the relevant transaction to be carried out by means of the application.

Further features and advantages of the invention emerge from the following description of exemplary embodiments according to the invention as well as further alternative embodiments in connection with the drawings, in which:

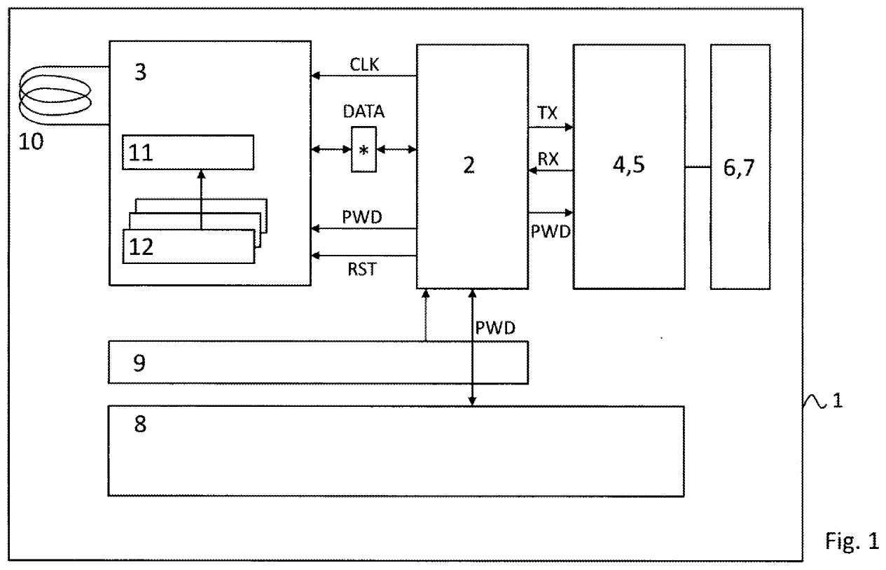

FIG. 1 shows a first embodiment of the device according to the invention;

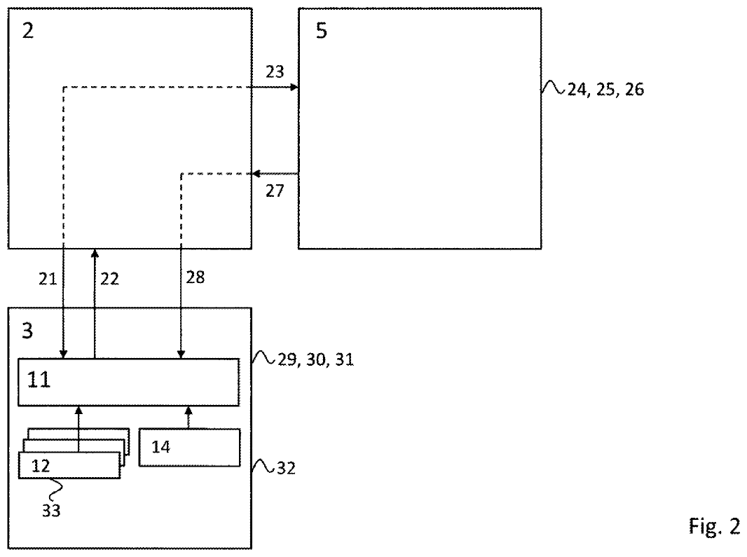

FIG. 2 shows a second embodiment of the device according to the invention;

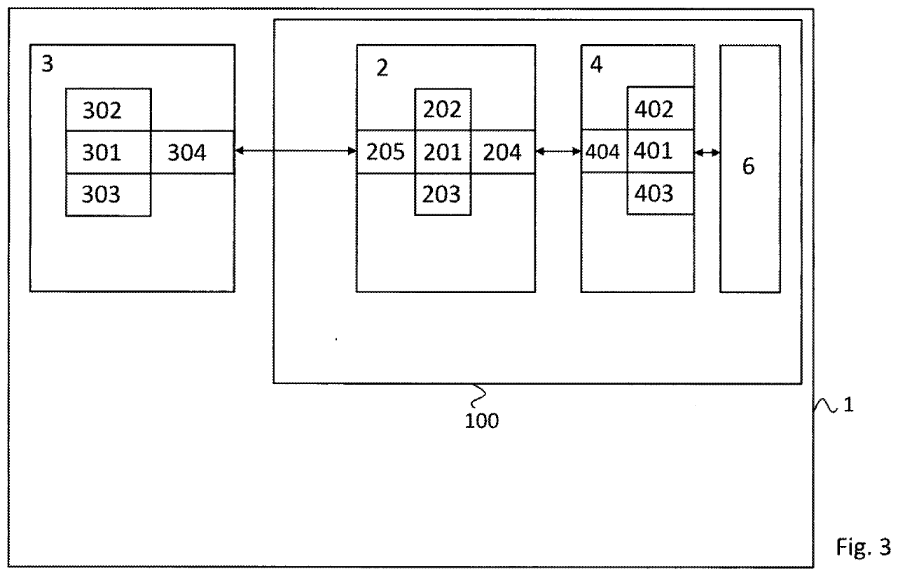

FIG. 3 shows a third embodiment of the device according to the invention; and

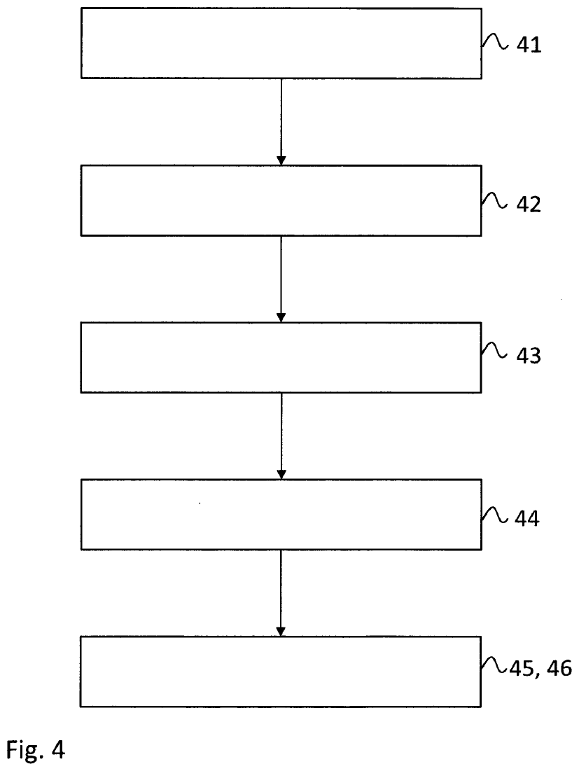

FIG. 4 shows the method according to the invention.

FIG. 1 shows a device 1 having a verification controller 2 which can be designed as a BLE controller, for example as a Bluetooth Low Energy Controller DIALOG BLE 5.0 DA14683 (WL-CSP53). The device 1 has a security element 3, e.g. a chip card, smart card, eSE, eUICC card or the like, for example an Infineon chip SLE78 with a G+D Sm@rt Café operating system. The device 1 further comprises a sensor controller 4, in particular a fingerprint controller 5, such as a Nuvoton NuMicro M480, and a sensor 6, such as a fingerprint sensor 7.

The BLE verification controller 2 is the main processor according to the embodiment in FIG. 1 and routes all data communication via the BLE channel to the fingerprint controller 5 (TX/RX) and on to the security element 3. In this context, FIG. 1 shows a data connection DATA and lines RST and CLK between the verification controller 2 and the security element 3 or the sensor controller 4, as well as data connections TX (“transmit”) and RX (“receive”).

The verification controller 2 is supplied with power by a battery 8, such as a lithium-ion battery. The verification controller 2 supplies the other components of the device 1 with power (PWD), in particular the security element 3 and the sensor controller 4. In addition, a power circuit 9 (“power switch circuit”) is connected to the verification controller 2. Applications 12 (e.g. JavaCard applets and/or qVSDC) are installed on the security element 3 and communicate either in a contact-based manner via the verification controller 2 or contactlessly via the connected antenna 10.

The fingerprint sensor 7 transmits biometric sensor data, which describe or represent a user feature of the user, to the fingerprint controller 5 which determines whether the user in question can be verified using the data. The corresponding user verification status is then transmitted in encrypted form to the verification controller 2 and from there on to the intermediary application 11 on the security element 3. Encryption largely eliminates manipulations, for example by means of logical attacks by malware in the verification controller or by physical attacks, for instance bit manipulations at weak points, such as the cable connections between the fingerprint controller 5 and verification controller 2 and security element 3.

In particular, the device provides a challenge-response security protocol (“Key Fob Fingerprint Security Protocol”) for securing the transmission of the user verification status via non-secure system components, such as the BLE controller or the cable connections of the device 1.

In the security element 3, the device 1 has an intermediary application 11 which accepts and stores the user verification status according to the security protocol. As soon as an application 12 is selected or a transaction is carried out using it, the operating system 14 of the security element 3 checks the user verification status and allows the selection or transaction only if the user verification status is positive. After the transaction has been carried out, the security element 3 resets the user verification status, such that another transaction, such as selecting the application, is not possible without renewed user verification.

The intermediary application 11, the fingerprint controller 5 and the verification controller 2 are pre-personalized during the manufacture of the device 1 within a secure environment with the key set EncKeyID and MacKeyID for the security protocol “Key Fob Fingerprint Security Protocol”.

FIG. 2 illustrates the sequence of user verification in a plurality of steps:

Step 21: As soon as the verification controller 2 (e.g. the BLE controller) determines that the user intends to carry out user verification with a fingerprint as a user feature, the verification controller 2 requests a challenge (e.g. a random number) from the intermediary application 11 in the security element using the GET_CHALLENGE command.

Step 22: The intermediary application 11 returns the challenge protected by the message authentication code HMAC to the verification controller.

Step 23: The verification controller 2 executes the MATCH command with the HMAC-secured challenge as the input parameter for the purpose of checking the fingerprint and references the keys EncKeyID and MacKeyID as additional input parameters.

Step 24: The fingerprint controller 5 checks the integrity of the challenge using the HMAC signature.

Step 25: The fingerprint controller 5 performs user verification using the fingerprint if the HMAC signature is correct. Otherwise, an error message is communicated to the verification controller 2.

Step 26: The fingerprint controller 5 encrypts the user verification status (OK Match, No Match) and secures it using a message authentication code (HMAC) with the aid of the keys EncKey and MacKey.

Step 27: The fingerprint controller 5 sends the encrypted and HMAC-secured user verification status back to the verification controller 2.

Step 28: The verification controller 2 forwards the user verification status to the intermediary application 11 on the security element 3.

Step 29: The intermediary application 11 on the security element 3 checks the HMAC signature of the received user verification status.

Step 30: If the HMAC signature is valid, the user verification status is decrypted by the intermediary application 11.

Step 31: The decrypted user verification status is stored in the intermediary application 11.

Step 32: The operating system 14 of the security element 3 asks for the user verification status from the intermediary application 11 together with the defined AIDs and rules and checks them.

Step 33: If user verification was successful and the application 12 has one of the defined AIDs, the operating system 14 allows the selection of the application 12 or the transaction using the application 12.

In the case of user verification according to FIG. 2, the user verification status is stored in the security element 3. Alternatively, the user verification status can be stored in the verification controller 2, e.g. in the BLE controller. For this purpose, the verification controller 2 generates a challenge and a corresponding message authentication code, such as an HMAC code, executes a MATCH command with the HMAC-secured challenge as an input parameter and references the cryptographic keys EncKeyID and MacKeyID as additional input parameters.

The fingerprint controller 5 checks the integrity of the challenge using the HMAC signature and performs user verification using the fingerprint if the HMAC signature is correct. Otherwise, an error message is passed to the verification controller 2. The fingerprint controller 5 then encrypts the user verification status (OK Match, No Match), secures it using a message authentication code (HMAC), and sends the encrypted and HMAC-secured user verification status back to the verification controller 2. The verification controller 2 then checks the message authentication code of the received user verification status and decrypts the user verification status if the HMAC signature is valid. The decrypted user verification status is finally stored in the verification controller 2.

In particular, the MATCH command can produce the following results:
OK Ready: Command received; wait for fingerprint (=user feature) on the sensor;
OK FP: Finger detected on the sensor (=sensor data);
OK Match: The selected template matches the finger on the sensor and return of the matching ID value;
NO Match: The selected template does not match the finger on the sensor.

The sensor controller 4, the fingerprint controller 5, the verification controller 2 and the intermediary application 11 require pre-stored keys for encryption and message authentication codes so that a user verification command can be executed. These keys are stored in the components mentioned during the manufacture of the device 1 and this storage is made permanent by a KEY_LOCK command.

For user verification based on the verification controller 2, the keys are stored in the verification controller 2 itself and are blocked by the latter to prevent overwriting. For user verification based on the security element, the keys EncKeyID_1 [16 bytes] and MacKeyID_1 [32 bytes] are stored in the security element 3 and in the sensor controller 4. For user verification based on the verification controller 2, the keys EncKeyID_2 and MacKeyID_2 are stored in the verification controller 2 and in the sensor controller 4. These keys can no longer be changed after the KEY_LOCK command has been executed.

FIG. 3 shows the device 1 comprising the security element 2 and the user verification element 100 with the verification controller 2, the sensor 6 and the sensor controller 4.

The verification controller 2 comprises a processor unit 201, a volatile memory 202 and a nonvolatile memory 203. In addition, the verification controller 2 has communication interfaces 204 and 205 for connection to the sensor controller 4 and the security element 3.

The security element comprises a processor unit 301, a volatile memory 302 and a nonvolatile memory 303, as well as a communication interface 304 connected to the verification controller 2.

The sensor controller 4 comprises a processor unit 401, a volatile memory 402, a non-volatile memory 403 and a communication interface 404 connected to the verification controller 2.

In this case, the user verification element 100 is designed and configured to perform user verification with the aid of the sensor 6 and to transmit the received user verification status in encrypted form to the intermediary application 11 on the security element 3. In particular, the user verification status is transmitted in encrypted form from the sensor controller 4 to the verification controller 2 and from there to the security element 3.

The security element 3 is designed and configured to decrypt the encrypted user verification status transmitted by the user verification element 100.

FIG. 4 finally illustrates the steps of the method according to the invention for authorizing an application 12 installed on a security element 3 by means of a device 1 according to the invention having a user verification element 100 and a security element 3:

Step 41: Capturing a user feature of a user of the device 1 by means of a sensor 6 of a user verification element 100 and generating sensor data characterizing the user feature by means of the sensor controller 4 of the user verification element 100;

Step 42: Deriving a user verification status from the sensor data by means of the user verification element or its sensor controller;

Step 43: Securely transmitting the user verification status from the user verification element 100 to the security element 3 for the purpose of authorizing the application 12 by way of the intermediation application 11;

Step 44: Storing the authorization information on the security element 3 (optional); and

Steps 45. 46: Selecting the application 12 on the security clement 3 and/or carrying out a transaction using the application 12. provided that the authorization information meets the requirements in the list (optional).

1-15. (canceled)

16. A method for authorizing an application installed on a security element, comprising the following steps:
capturing a user feature by a sensor of a user verification element and generating sensor data that characterize the user feature;
deriving a user verification status from the sensor data by the user verification element; and
transmitting the user verification status from the user verification element to the security element for the purpose of authorizing the application by way of the security element.

17. The method according to claim 16, comprising the step of providing a device comprising the security element and the user verification element.

18. The method according to claim 16, wherein the user verification status is derived by a sensor controller of the user verification element that is assigned to the sensor and/or the user verification status is transmitted from a verification controller of the user verification element to an intermediary application of the security element.

19. The method according to claim 18, wherein the verification controller derives the user verification status from the sensor data and/or the sensor controller determines whether a positive user verification status results from the sensor data and forwards the derived user verification status to the verification controller.

20. The method according to claim 16, wherein data communication between the user verification element and the security element is encrypted and/or at least partially secured with message authentication codes.

21. The method according to claim 16, wherein the user verification status is transmitted from the user verification element to the security element according to a security protocol.

22. The method according to claim 18, wherein the sensor controller and/or the verification controller and/or the intermediary application is/are pre-personalized, in particular with a cryptographic key set relating to the security protocol.

23. The method according to claim 18, wherein the user verification status is transmitted from the verification controller to the intermediary application in encrypted form by a security protocol relating to a challenge-response method.

24. The method according to claim 16, wherein the user feature is captured by a biometric sensor of the user verification element, in particular by a fingerprint sensor.

25. The method according to claim 16, wherein the authorization of the application comprises the further step of:
selecting the application on the security element and/or carrying out a transaction using the application, provided that an intermediary application of the user verification element detects a positive user verification status.

26. The method according to claim 25, wherein, if there is a positive user verification status, the intermediary application determines an application installed on the security element, which application is selected and/or with the aid of which application a transaction is carried out.

27. The method according to claim 25, wherein the intermediary application has a list of commands, during the execution of which the user verification status of an application is reset, and/or
resets the user verification status after selecting the application and/or carrying out the transaction, such that further selection and/or carrying-out of a transaction requires user verification.

28. The method according to claim 25, wherein the transaction is carried out contactlessly by the security element, and/or an authentication transaction, a payment transaction and/or an access control transaction is/are carried out as a transaction.

29. A device comprising a user verification element having a sensor and a security element having an application installed thereon,
wherein the user verification element is configured to capture a user feature by the sensor and to derive therefrom a user verification status that characterizes the user feature, and to transmit the user verification status to the security element; and
the security element is configured to accept the user verification status in order to authorize the application.

30. The device according to claim 29, wherein the device is configured to carry out a method for authorizing an application installed on a security element, comprising the following steps:
capturing a user feature by a sensor of a user verification element and generating sensor data that characterize the user feature;
deriving a user verification status from the sensor data by the user verification clement; and
transmitting the user verification status from the user verification clement to the security clement for the purpose of authorizing the application by way of the security clement.
